(19) United States
(12) Patent Application Publication
(10) Pub. No.: US 2024/0407545 A1
(43) Pub. Date: Dec. 12, 2024

(54) HEADBORAD FOLD-OUT CONSOLE WITH HEIGHT-ADJUSTABLE SLIDING HINGE

(71) Applicant: NINE WOOD TRADING CO., LIMITED, Hongkong (CN)

(72) Inventor: JUNTAO SHI, Haining (CN)

(21) Appl. No.: 18/208,856

(22) Filed: Jun. 12, 2023

(51) Int. Cl. A47B 23/06; A47C 19/02; A47C 21/00; H04R 1/02

(52) U.S. Cl. CPC A47B 23/06; A47C 19/022; A47C 21/003; H04R 1/025; H04R 2420/07

(57) ABSTRACT

A headboard fold-out console with height adjustable sliding hinge comprises a bed body and a headboard connected to the bed body, a receiving groove is formed on the headboard, and a slideway type shaft hinge is arranged at lower portion of a side wall at one end of the receiving groove. By providing a receiving groove on the headboard and arranging a slideway type shaft hinge in the receiving groove, the table body is connected with the slideway type shaft hinge. The table body can rotate around the slideway type shaft hinge, so that the table body can be flipped onto the mattress. At the same time, the table body can move along the track of the slideway type shaft hinge, and then the height of the table body can be adjusted, so that the table body is suitable for mattresses with different heights.

### TECHNICAL FIELD

The present application relates to the field of beds, in particular to a headboard fold-out console with height adjustable sliding hinge.

### BACKGROUND

Beds are generally used in bedrooms, dormitories, wards, hotels and other places, and are necessary for human daily sleep. Some beds are equipped with regular bed warming, weight record monitoring, bed sheet fixing, sleep monitoring, etc., and the design tends to be smart. Old-fashioned beds are usually made of wood, which is strong and practical. Now stainless steel and metal can also be used as the main material, which can effectively increase the service performance and life of the bed. Generally, there are dozens of parts. The standard bed is composed of headboard, bed frame, bed end, bed legs, bed board, mattress, electric push rod, chips, guards, casters, dining table, and equipment storage tray. Its production uses processes such as punching, assembly, welding, pressure riveting, rust removal, and plastic spraying. It has the characteristics of flame retardant, rodent-proof, moth-proof, durable, practical and simple, beautiful, easy to clean, easy to move, intelligent and safe.

When using the bed, some beds will have a reversible small table installed at the headboard, and the small table can be turned over to the bed so that the small table can be placed horizontally on the bed. Further, in order to meet people's needs, cup holder slots will be provided on the small table, and various tools will be installed for people to use. However, the existing small tables can only perform a simple turning function. When changing mattresses according to people's needs, such as the replacement of summer and winter mattresses, because the mattress types are different, there are differences in their heights, so the use of its small table will also be affected. Therefore, when the small table is turned over to a lower or higher mattress, the small table will be tilted, which makes the small table inconvenient to use.

### SUMMARY

In order to make up for the above shortcomings, the present application provides a headboard fold-out console with height adjustable sliding hinge, aiming at solving the problem that the existing small table is difficult to adjust the height according to the height of the mattress.

The embodiment of the present application provides a headboard fold-out console with height adjustable sliding hinge, comprising a bed body and a headboard connected to the bed body, a receiving groove is formed on the headboard, and a slideway type shaft hinge is arranged at a lower portion of a side wall at one end of the receiving groove, a table body is arranged on the slideway type shaft hinge, and the table body can rotate around the slideway type shaft hinge, so that the table body can be rotated out or into the receiving groove, and can slide along a track of the slideway type shaft hinge, so that the table body can be raised or lowered in the receiving groove.

In a specific embodiment, the slideway type shaft hinge comprises a mounting plate mounted on the lower portion of the side wall at one end of the receiving groove and two limiting blocks mounted on the mounting plate, the two limiting blocks and the mounting plate are arranged parallel to each other, and opposite side walls of the two limiting blocks are respectively provided with a limiting groove with both ends open.

In a specific embodiment, the slideway type shaft hinge further comprises a connecting plate arranged on bottom of a side wall at one end of the table body, and the connecting plate is fixedly provided with a connecting shaft, one end of the connecting shaft is connected with a sliding block arranged in a circle, and the sliding block is slidably arranged in the two limiting grooves.

In a specific embodiment, the table body rotates around the connecting shaft and simultaneously moves along a sliding track of the sliding block, a limiting screw is arranged on the mounting plate, and the limiting screw is located between the two limiting grooves and is arranged close to top of the mounting plate.

In a specific embodiment, the bed body comprises a bedside and a bed end connected to the bedside, and the same mattress is placed on the bedside and the bed end, and the bedside is connected with the headboard, so that the table body can be rotated onto the mattress.

In a specific embodiment, a resting surface of the headboard is inclined, and the inclined surface is embedded with backrests and headrests sequentially from bottom to top.

In a specific embodiment, two of the backrest and the headrest are provided, and the receiving groove is formed on the inclined surface of the headboard and is located between the two backrests and the two headrests.

In a specific embodiment, a Bluetooth speaker and a charging device are installed on a side wall at one end of the headboard.

In a specific embodiment, the charging device comprises a pocket wireless charger (60) and a USB interface installed on the side wall of the headboard.

In a specific embodiment, a bump that can be buckled on the headboard is arranged on a head of the table body, wherein cup holders and a mobile phone stand charging base are arranged on back of the table body.

The beneficial effect of the present application: By providing a receiving groove on the headboard and arranging a slideway type shaft hinge in the receiving groove, the table body is connected with the slideway type shaft hinge. At the same time, the table body can rotate around the slideway type shaft hinge, so that the table body can be flipped onto the mattress. At the same time, the table body can move along the track of the slideway type shaft hinge, and then the height of the table body can be adjusted, so that the table body is suitable for mattresses with different heights. Thus, after the table body is turned over, the table body can be placed horizontally on the mattress without being tilted, so as to ensure the normal use of the table body.

### BRIEF DESCRIPTION OF DRAWINGS

In order to more clearly illustrate the technical solutions of the embodiments of the present application, the following will briefly introduce the drawings that need to be used in the embodiments. It should be understood that the following drawings only illustrate certain embodiments of the present application, and thus should not be considered as limiting the scope. For those skilled in the art, other related drawings can also be obtained based on these drawings without creative effort.

FIG. 1 is a schematic diagram of the main structure of a headboard fold-out console with height adjustable sliding hinge according to an embodiment of the present application;

FIG. 2 is a schematic diagram of the turning structure of the table body in the headboard fold-out console with height adjustable sliding hinge according to the embodiment of the present application;

FIG. 3 is a state view of mattresses with different heights on the headboard fold-out console with height adjustable sliding hinge according to the embodiment of the present application;

FIG. 4 is a schematic structural diagram of the mounting plate in the headboard fold-out console with height adjustable sliding hinge according to the embodiment of the present application;

FIG. 5 is a schematic structural diagram of the connecting plate in the headboard fold-out console with height adjustable sliding hinge according to the embodiment of the present application;

FIG. 6 is a schematic structural diagram of the slideway type shaft hinge in the headboard fold-out console with height adjustable sliding hinge according to the embodiment of the present application.

Reference signs: 10. Bed body; 110. Bedside; 120. Bed end; 130. Mattress; 20. Headboard; 210. Backrest; 220. Headrest; 230. Bluetooth speaker; 240. Charging device; 30. Receiving groove 40. Slideway type shaft hinge; 410. Mounting plate; 420. Limiting block; 430. Limiting groove; 440. Connecting plate; 450. Connecting shaft; 460. Sliding block; 50. Table body; 510. Bump; 520. Cup holder; 530. Mobile phone stand charging base; 60. Pocket wireless charger; 70. USB interface; 480. Limiting screw.

### DETAILED DESCRIPTION

The technical solutions in the embodiments of the present application will be described below with reference to the drawings in the embodiments of the present application.

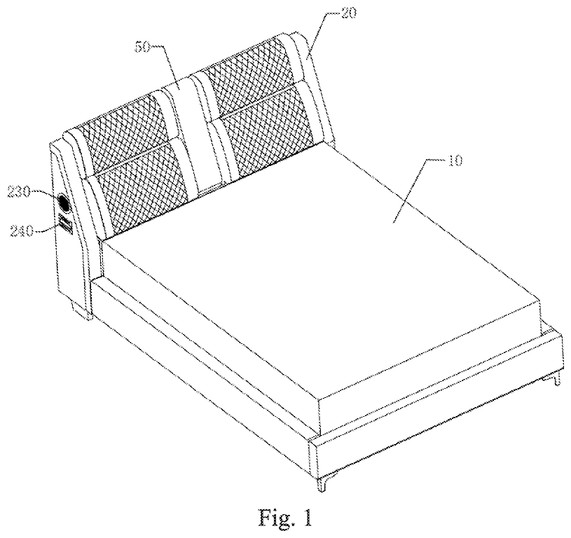

Please refer to FIGS. 1-6, the present application provides a headboard fold-out console with height adjustable sliding hinge, comprising a bed body 10 and a headboard 20 connected to the bed body 10, a receiving groove 30 is formed on the headboard 20, and a slideway type shaft hinge 40 is arranged at a lower portion of a side wall at one end of the receiving groove 30, a table body 50 is arranged on the slideway type shaft hinge 40, and the table body 50 can rotate around the slideway type shaft hinge 40, so that the table body 50 can be rotated out or into the receiving groove 30, and can slide along a track of the slideway type shaft hinge 40, so that the table body 50 can be raised or lowered in the receiving groove 30.

When setting, the table body 50 can be accommodated in the receiving groove 30, and the specific material and structure of the table body 50 are prior art. At the same time, the table body 50 can slide on the slideway type shaft hinge 40 to achieve the purpose of adjusting its height.

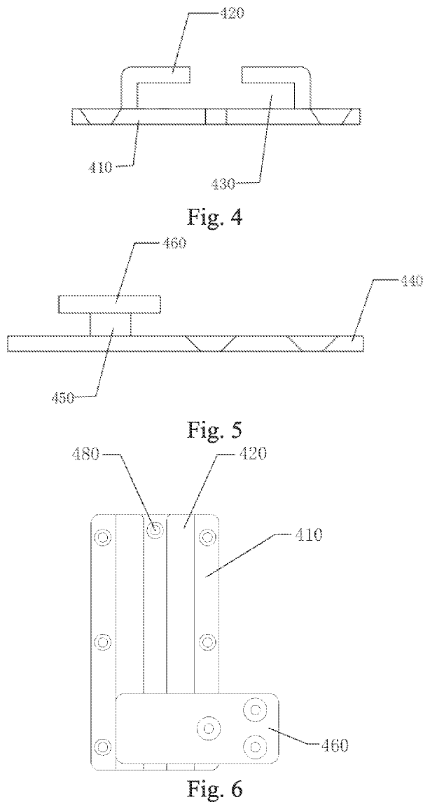

Please refer to FIG. 4, the slideway type shaft hinge 40 comprises a mounting plate 410 mounted on the lower portion of the side wall at one end of the receiving groove 30 and two limiting blocks 420 mounted on the mounting plate 410, the two limiting blocks 420 and the mounting plate 410 are arranged parallel to each other, and opposite side walls of the two limiting blocks 420 are respectively provided with a limiting groove 430 with both ends open.

It should be noted that the mounting plate 410 is provided with a number of mounting holes, and the mounting plate 410 can be fixed on the side wall of the receiving groove 30 through existing screws. Specifically, a corresponding threaded hole is provided on the side wall of the receiving groove 30, and a screw rod is installed in the threaded hole through the mounting hole to complete the installation of the mounting plate 410.

Please refer to FIG. 5 and FIG. 6, the slideway type shaft hinge 40 further comprises a connecting plate 440 arranged on bottom of a side wall at one end of the table body 50, and the connecting plate 440 is fixedly provided with a connecting shaft 450, one end of the connecting shaft 450 is connected with a sliding block 460 arranged in a circle, and the sliding block 460 is slidably arranged in the two limiting grooves 430. The table body 50 rotates around the connecting shaft 450 while moving along the slide track of the sliding block 460. A limiting screw 480 is arranged on the mounting plate 410, and the limiting screw 480 is located between the two limiting grooves 430 and is arranged close to top of the mounting plate 410.

Specifically, the sliding block 460 is slidably arranged between the two limiting blocks 420, so that the sliding block 460 can slide along the inner wall of the limiting groove 430, so as to realize the lifting purpose of the table body 50. Simultaneously, the sliding block 460 is arranged in a circular type, and then the sliding 460 is rotated, so that the table body 50 can rotate with the sliding block 460 as the center, so as to realize the secret rotation of the table body 50.

Further, on the top of the mounting plate 410 and between the two limiting grooves 430, a through hole is formed. In addition, a threaded hole corresponding to the through hole is provided on the side wall of the receiving groove 30, and then the limiting screw 480 is connected to the threaded hole through the through hole. The head of the limiting screw 480 is located outside the through hole and between the two limit grooves 430, thereby limiting the sliding block 460 to prevent it from falling off from the top of the limiting groove 430, thereby preventing the table body 50 from falling off. In addition, a threaded hole may also be provided on the mounting plate 410 to connect the limiting screw 480 to the threaded hole, thereby preventing the sliding block 460 from falling off.

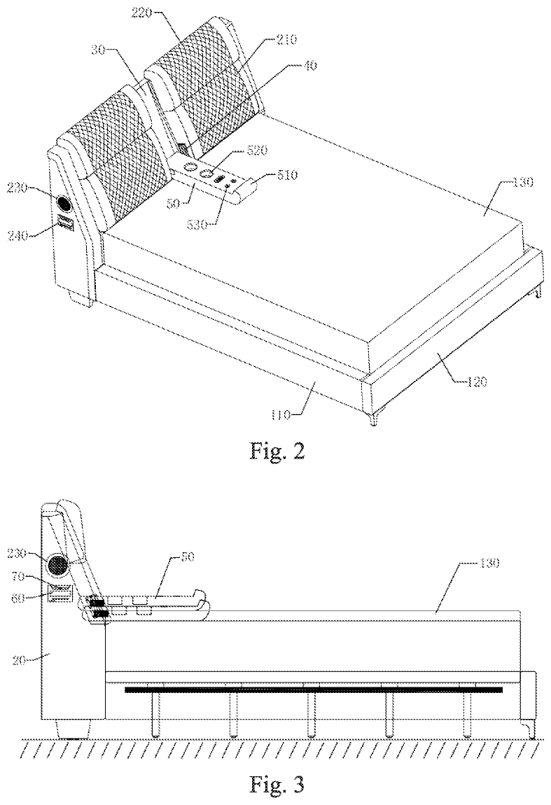

Please refer to FIG. 1 and FIG. 2, the bed body 10 comprises a bedside 110 and a bed end 120 connected to the bedside 110, and the same mattress 130 is placed on the bedside 110 and the bed end 120, and the bedside 110 is connected with the headboard 20, so that the table body 50 can be rotated onto the mattress 130.

The specific structures of the bedside 110, the bed end 120 and the mattress 130 are prior art, and in addition, the connection structure with the headboard 20 is also the prior art. Since there are differences in the heights of different types of mattresses 130, after the mattress 130 is placed on the bedside 110 and the bed end 120, the height between it and the table body 50 is also different, and the height of the table body 50 can be adjusted. so that the table body 50 can lie flat on the mattress 130 after turning over.

Please refer to FIG. 1 and FIG. 2, a resting surface of the headboard 20 is inclined, and the inclined surface is embedded with backrests 210 and headrests 220 sequentially from bottom to top. Two of the backrest 210 and the headrest 220 are provided, and the receiving groove 30 is formed on the inclined surface of the headboard 20 and is located between the two backrests 210 and the two headrests 220.

In the specific setting, the shape of the receiving groove 30 is adapted to the shape of the headboard 20, that is, the section of the receiving groove 30 is also inclined, and the slideway type shaft hinge 40 is also inclined, and its inclination angle is the same as that of the receiving groove 30.

Please refer to FIGS. 1-3, a Bluetooth speaker 230 and a charging device 240 are installed on a side wall at one end of the headboard 20. The charging device 240 comprises a pocket wireless charger 60 and a USB interface 70 installed on the side wall of the headboard 20. A bump 510 that can be buckled on the headboard 20 is arranged on a head of the table body 50, wherein cup holders 520 and a mobile phone stand charging base 530 of a holder are arranged on back of the table body 50.

Specifically, the Bluetooth speaker 230 can be connected with mobile phones and other devices to play music, and the charging device 240 is used for charging. In addition, after the table body 50 is turned over into the receiving groove 30, the table body 50 can be pushed to move downward, so that the bump 510 can be buckled on the top of the receiving groove 30.

When the headboard fold-out console with height adjustable sliding hinge is used: assemble and connect the bedside 110, the bed end 120 and the headboard 20; then install the mounting plate 410 in the receiving groove 30, and install the connecting plate 440 on the table body 50; then insert the sliding block 460 along the bottom of the limiting groove 430, and then push the table body 50 into the receiving groove 30 as a whole. At the same time, the bump 510 is hooked on the top of the receiving groove 30 to realize the limit of the table body 50. Further, the sliding block 460 is limited to prevent it from falling off from the bottom of the limiting groove 430, and then the mattress 130 can be placed on the assembled bed.

When in use, the table body 50 can be rotated to overturn the table body 50 onto the mattress 130, and the table body 50 is placed horizontally, and a cup holder 520 is arranged on it, which can place items such as cups or bottles. After replacing the mattress 130, turn over the table body 50 to push the table body 50 to move, so that the sliding block 460 slides in the limiting groove 430, and then adjust the height of the table body 50 to be suitable for the mattress 130 with different heights. After the table body 50 is turned over, it can still lie horizontally on the mattress 130.

It should be noted that the specific models and specifications of the Bluetooth speaker 230, the mobile phone stand charging base 530, the pocket wireless charger 60 and the USB interface 70 need to be selected according to the actual specifications of the device, and the specific selection calculation method adopts the existing technology in the art, so it will not be described in detail.

The power supply and principle of the Bluetooth speaker 230, the mobile phone stand charging base 530, the pocket wireless charger 60 and the USB interface 70 are clear to those skilled in the art, and will not be described in detail here.

The foregoing is only an embodiment of the present application, and is not intended to limit the protection scope of the present application. For those skilled in the art, various modifications and changes may occur in this application. Any modifications, equivalent replacements, improvements, etc. made within the spirit and principles of this application shall be included within the protection scope of this application. It should be noted that like numerals and letters denote similar items in the following figures, therefore, once an item is defined in one figure, it does not require further definition and explanation in subsequent figures.

What is claimed is:

1. A headboard fold-out console with height adjustable sliding hinge comprising a bed body (10) and a headboard (20) connected to the bed body (10), a receiving groove (30) is formed on the headboard (20), and a slideway type shaft hinge (40) is arranged at a lower portion of a side wall at one end of the receiving groove (30), a table body (50) is arranged on the slideway type shaft hinge (40), and the table body (50) can rotate around the slideway type shaft hinge (40), so that the table body (50) can be rotated out or into the receiving groove (30), and can slide along a track of the slideway type shaft hinge (40), so that the table body (50) can be raised or lowered in the receiving groove (30).

2. The headboard fold-out console with height adjustable sliding hinge according to claim 1, wherein the slideway type shaft hinge (40) comprises a mounting plate (410) mounted on the lower portion of the side wall at one end of the receiving groove (30) and two limiting blocks (420) mounted on the mounting plate (410), the two limiting blocks (420) and the mounting plate (410) are arranged parallel to each other, and opposite side walls of the two limiting blocks (420) are respectively provided with a limiting groove (430) with both ends open.

3. The headboard fold-out console with height adjustable sliding hinge according to claim 2, wherein the slideway type shaft hinge (40) further comprises a connecting plate (440) arranged on bottom of a side wall at one end of the table body (50), and the connecting plate (440) is fixedly provided with a connecting shaft (450), one end of the connecting shaft (450) is connected with a sliding block (460) arranged in a circle, and the sliding block (460) is slidably arranged in the two limiting grooves (430).

4. The headboard fold-out console with height adjustable sliding hinge according to claim 3, wherein the table body (50) rotates around the connecting shaft (450) and simultaneously moves along a sliding track of the sliding block (460), a limiting screw (480) is arranged on the mounting plate (410), and the limiting screw (480) is located between the two limiting grooves (430) and is arranged close to top of the mounting plate (410).

5. The headboard fold-out console with height adjustable sliding hinge according to claim 1, wherein the bed body (10) comprises a bedside (110) and a bed end (120) connected to the bedside (110), and the same mattress (130) is placed on the bedside (110) and the bed end (120), and the bedside (110) is connected with the headboard (20), so that the table body (50) can be rotated onto the mattress (130).

6. The headboard fold-out console with height adjustable sliding hinge according to claim 1, wherein a resting surface of the headboard (20) is inclined, and the inclined surface is embedded with backrests (210) and headrests (220) sequentially from bottom to top.

7. The headboard fold-out console with height adjustable sliding hinge according to claim 6, wherein two of the backrest (210) and the headrest (220) are provided, and the receiving groove (30) is formed on the inclined surface of the headboard (20) and is located between the two backrests (210) and the two headrests (220).

8. The headboard fold-out console with height adjustable sliding hinge according to claim 6, wherein a Bluetooth speaker (230) and a charging device (240) are installed on a side wall at one end of the headboard (20).

9. The headboard fold-out console with height adjustable sliding hinge according to claim 8, wherein the charging device (240) comprises a pocket wireless charger (60) and a USB interface (70) installed on the side wall of the headboard (20).

10. The headboard fold-out console with height adjustable sliding binge according to claim 1, wherein a bump (510) that can be buckled on the headboard (20) is arranged on a head of the table body (50), wherein cup holders (520) and a mobile phone stand charging base (530) are arranged on back of the table body (50).
